(19) United States
(12) Patent Application Publication
(10) Pub. No.: US 2010/0315439 A1
(43) Pub. Date: Dec. 16, 2010

(54) Using motion detection to process pan and zoom functions on mobile computing devices

(75) Inventors: Yun-Wu Huang, Chappaqua, NY (US); John J. Ponzo, Shrub Oak, NY (US)

Correspondence Address: FERENCE & ASSOCIATES LLC, 409 BROAD STREET, PITTSBURGH, PA, 15143, US

(73) Assignee: International Business Machines Corporation, Armonk, NY (US)

(21) Appl. No.: 12/484,330

(22) Filed: Jun. 15, 2009

(51) Int. Cl. G06F 3/03; G09G 5/00; G06F 3/01

(52) U.S. Cl. 345/661; 345/156; 715/863

(57) ABSTRACT

An arrangement on a mobile computing device wherein actual motion of the device can be employed to control, among other things, the panning, zooming, paging and scrolling of a graphic user interface. The user would need only use only one hand to hold the device and simultaneously undertake the aforementioned functions, e.g., by moving or gesturing with the device to perform pan, zoom, page and/or scroll functions on an image or document currently displayed on the device. Thus, the screen wouldn't necessarily need to be a touch screen, and the user wouldn't necessarily need to ever touch the screen.

### BACKGROUND

The field of the invention is mobile computing devices, particularly those with small screens that permit pan and zoom functions.

Mobile computing devices with smaller screens, and which normally include a telephony function, have proliferated in recent years to permit users to essentially carry a miniature computer in their pocket, allowing for such varied functions as internet access and smaller-scale word processing in the palm of one's hand. The screens in such devices often permit touch activation with a stylus or a user's fingers for added versatility and functionality.

Different incarnations of the “iPhone®” manufactured by Apple, Inc. of Cupertino, Calif., include a touchscreen capability wherein, among other things, a user's fingers can directly control pan and zoom functions of the screen display. For instance, touching the screen with a finger and then dragging the finger over the screen can afford a panning function, while applying two fingers to the screen and dragging them closer to or further apart from one another can afford zoom-out and zoom-in functions, respectively.

Finger-activated functions still emerge as two-handed functions, in that one hand is needed to hold the device while the other is used for the aforementioned finger activation and manipulation. A touchscreen is also required and with the constant finger activation and manipulation it can easily become smudged or marred from any moist and grease imparted by the user's fingers.

Accordingly, the inventors have recognized a need for overcoming the functional and practical disadvantages, mentioned above, associated with touchscreens as well as other disadvantages.

### BRIEF SUMMARY

In accordance with at least one presently preferred embodiment of the present invention, there is broadly contemplated herein an arrangement on a mobile computing device wherein actual motion of the device can be employed to control, among other things, the panning, zooming, paging and scrolling of a graphic user interface. The user would need only use only one hand to hold the device and simultaneously undertake the aforementioned functions, e.g., by moving or gesturing with the device to perform pan, zoom, page and/or scroll functions on an image or document currently displayed on the device. Thus, the screen wouldn't necessarily need to be a touch screen, and the user wouldn't necessarily need to ever touch the screen.

In summary, one aspect of the invention provides an apparatus comprising: a mobile computing device; the mobile computing device comprising a main memory and system processor; the mobile computing device being displaceable by hand; aid mobile computing device further comprising a display for displaying an image; said mobile computing device further comprising a motion detection module; aid motion detection module acting to: detect displacement of the mobile computing device; detect a direction of displacement of the mobile computing device; and alter an appearance of an image on the display responsive to detection of displacement and a direction of displacement of the mobile computing device.

Another aspect of the invention provides a method comprising: providing a mobile computing device comprising a main memory and system processor; displaying an image on the mobile computing device; displacing the mobile computing device by hand; detecting displacement of the mobile computing device; detecting a direction of displacement of the mobile computing device; and altering an appearance of the image responsive to the detecting of displacement and the detecting of a direction of displacement.

Furthermore, an additional aspect of the invention provides a computer program product comprising: a computer readable storage medium having computer readable program code embodied therewith, the computer readable program code comprising: computer readable program code configured to display an image on the mobile computing device; computer readable program code configured to detect displacement of the mobile computing device; computer readable program code configured to detect a direction of displacement of said mobile computing device; and computer readable program code configured to alter an appearance of the image responsive to said detecting of displacement and said detecting of a direction of displacement.

A further aspect of the invention provides a computer program product comprising: a computer readable storage medium having computer readable program code embodied therewith, the computer readable program code comprising: computer readable program code configured to detect a direction of displacement of a mobile computing device; computer readable program code configured to alter an appearance of an image displayed on said mobile computing device responsive to said detecting a direction of displacement of a mobile computing device; wherein to alter an appearance of an image displayed on said mobile computing device comprises one or more of implementing a zoom function, implementing a panning function, and implementing a paging function.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

FIG. 1 schematically illustrates components of a mobile computing device.

FIG. 1a schematically illustrates certain components of a mobile computing device.

FIG. 2 schematically illustrates a mobile computing device and directions of motion.

FIG. 3 schematically illustrates a motion detection module.

### DETAILED DESCRIPTION

It will be readily understood that the components of the embodiments of the present invention, as generally described and illustrated in the Figures herein, may be arranged and designed in a wide variety of different configurations. Thus, the following more detailed description of the embodiments of the apparatus, system, and method of the present invention, as represented in the Figures, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the various embodiments of the invention can be practiced without one or more of the specific details, or with other methods, components, materials, etc. In other instances, well-known structures, materials, or operations are not shown or described in detail to avoid obscuring aspects of the embodiments of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes that are consistent with the invention as claimed herein.

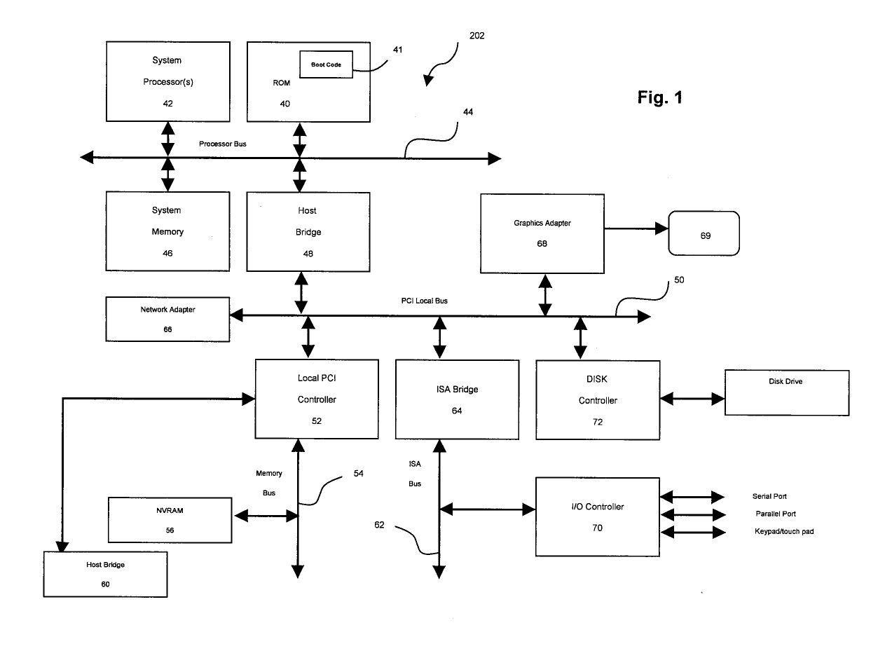

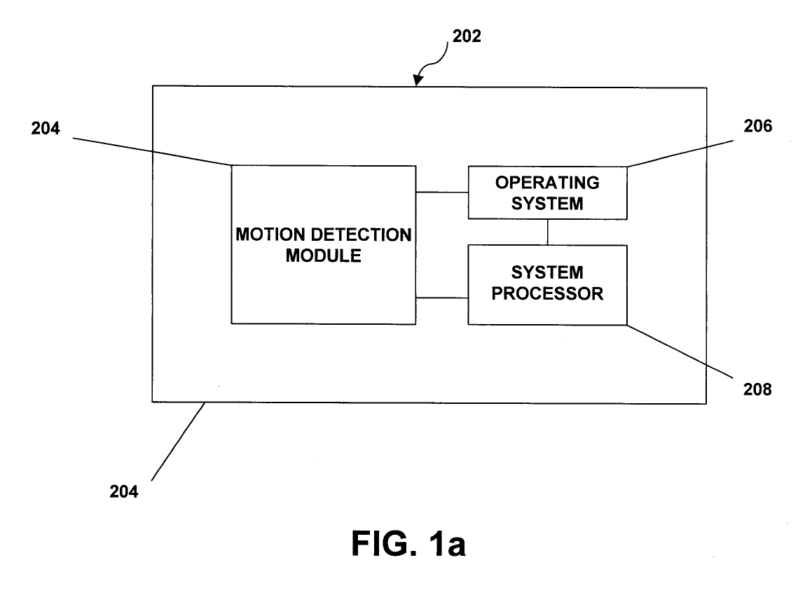

Referring now to FIG. 1, there is depicted a block diagram of an illustrative embodiment of a mobile computing device 202. The illustrative embodiment depicted in FIG. 1 may be mobile computing device such as a smart phone or other computing device. As is apparent from the description, however, the present invention is applicable any appropriately configured computing device, as described herein.

As shown in FIG. 1, mobile computing device 202 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation or ARM Ltd., is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces electronic device 100 to LAN 10, and graphics adapter 68, which interfaces electronic device 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Mobile computing device 202 further includes Industry Standard Architecture (ISA) bus 62, which is coupled to PCI local bus 50 by ISA bridge 64. Coupled to ISA bus 62 is an input/output (I/O) controller 70, which controls communication between electronic device 100 and attached peripheral devices such as a keypad, touch pad, and a disk drive. In addition, I/O controller 70 supports external communication by electronic device 100 via serial and parallel ports. The USB Bus and USB Controller (not shown) are part of the Local PCI controller (52).

FIG. 1a is a simplified drawing schematically illustrating certain components of a mobile computing device 202 in accordance with a presently preferred embodiment of the present invention. Indicated at 204 is a motion-detection module which interfaces with an operating system 206 (which could include or be part of a main memory) and system processor 208 of device 202. The makeup and functioning of a motion-detection module in accordance with at least one embodiment of the present invention will be better understood from further discussion below.

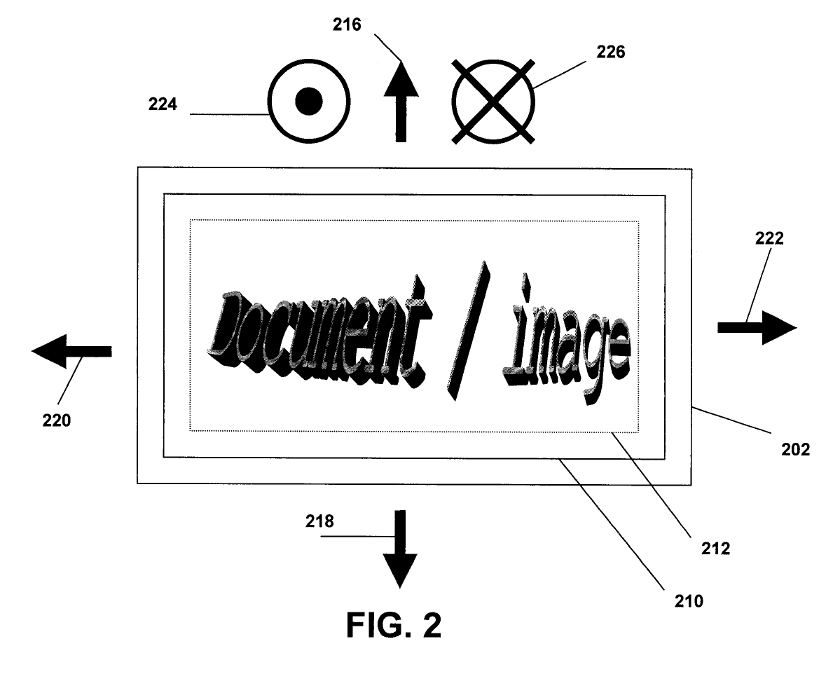

FIG. 2 again schematically illustrates mobile computing device 202, this time showing a display screen 210 and an image or document displayed 212 thereon. The image or document 212, for its part, can be displayed by way of a graphical user interface (GUI) of essentially any suitable type. Preferably, the module 204 (FIG. 1a) is configured to track and monitor movements of the mobile computing device 202 in space such as, e.g., movements to the left, right, “up” and “down” (indicated by arrows 216/218/220/222, respectively) as well as movements “towards” and “away from” the user (indicated by symbols 224/226, respectively). More precisely, “up”/“down”/“left”/“right” 216/218/220/222 are preferably coplanar with the lie of the screen 210. Further, “up” 216 preferably may be defined as a direction parallel to and oriented along an upward direction of image/document 212 (wherein “upward” corresponds sensibly to a perceptually upper portion of the screen 210 in accordance with the image/document 212 shown thereon), “down” 218 preferably may be defined as a direction parallel to and oriented along a downward direction of image/document 212 screen (wherein “downward” corresponds sensibly to a perceptually lower portion of the screen 210 in accordance with the image/document 212 shown thereon), with the “left” and “right” (220/222) directions appropriately running in perpendicular to “up”/“down” 216/218. “Towards” 224, for its part, preferably is defined in perpendicular to the lie of the screen 210 and along that general direction in which image/document 212 is displayed towards a user, with “away from” 226 being defined in that direction which is directly opposite with respect to “towards” (224).

Preferably, movements in directions 216-226 sufficient for detection by module 204 (FIG. 1) can preferably be brought about by the user imparting a quick, sharp displacement of the device 202 in or towards the direction in question, but other types of movements can also prompt detection by module 204 (FIG. 1).

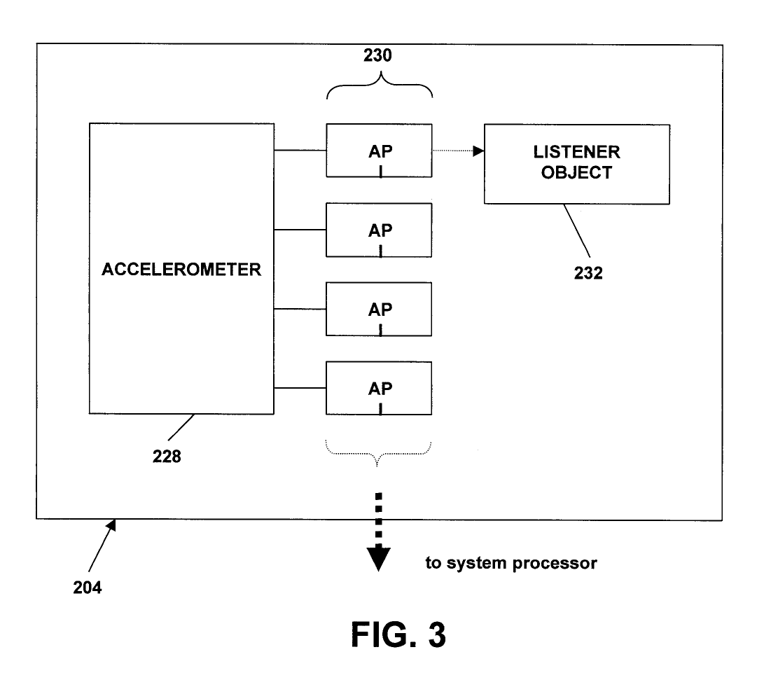

FIG. 3 schematically illustrates motion-detection module 204 in more detail. Preferably, module 204 may include an accelerometer 228 capable of detecting displacement, velocity and changes in orientation of mobile computing device 202 (FIG. 2). Typically, an accelerometer 228 associated with a mobile computing device (such as a mobile phone) includes a set of application program interfaces (API's), and these are indicated at 230. Preferably, at least one API (230) may be configured for processing data related to the aforementioned displacement, velocity and orientation changes. This may be done by calling code in the form of a listener object 232 which, responsive to a spatial location or orientation change, will specifically determine quantitatively what changes took place and in which direction(s).

Thence through interaction with system processor 208 (FIG. 1a), pre-determined protocols can preferably govern the action next to take place. For instance, sharp displacement “up” or “down” (224/226 in FIG. 2) can prompt paging backward or forward, respectively, through a document at 212 (FIG. 2). Sharp displacements in any direction (216/218/220/222) coplanar with respect to screen 210 (FIG. 2) can preferably prompt a corresponding panning motion through an image or document 212 (FIG. 2), while a sharp displacement “towards” or “away from” (224/226) in FIG. 2) can cause, respectively, a zooming into or out of an image/document 212 (FIG. 2). It should be noted that the above pre-determined protocols are merely non-limiting and exemplary of presently preferred embodiments of the invention. One or more modifications to these pre-determined protocols can be make, such as implementing the opposite of the pre-determined protocols mentioned above.

It should be understood that as API's (228) can typically be included with an accelerometer, the manufacturer or even an end user can be in a position to tailor API's to perform a desired function such as those discussed hereinabove. Thus, essentially any suitable mobile computing device (e.g., mobile phone) can be taken and undergo software-only modifications to permit functions of the type described hereinabove.

In brief recapitulation, it will be appreciated from the foregoing that, in accordance with at least one presently preferred embodiment of the present invention, a motion-detection module may be employed, inclusive of an accelerometer, to caption certain motions of a mobile computing device. Using the output of the motion-detection module and heuristics based on empirical analyses, certain motions can be respectively mapped to predefined GUI functions such as panning, zooming and paging.

Accelerometers, of a general type of which may be employed in accordance with at least one embodiment of the present invention, are discussed in U.S. Published Patent Application US20080174570, “Touch Screen Device, Method and Graphical User Interface for Determining Commands by Applying Heuristics”.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus comprising:
a mobile computing device;
said mobile computing device comprising a main memory and system processor;
said mobile computing device being displaceable by hand;
said mobile computing device further comprising a display for displaying an image;
said mobile computing device further comprising a motion detection module;
said motion detection module acting to:
detect displacement of said mobile computing device;
detect a direction of displacement of said mobile computing device; and
alter an appearance of an image on said display responsive to detection of displacement and a direction of displacement of said mobile computing device.

2. The apparatus according to claim 1, wherein said motion detection module comprises an accelerometer.

3. The apparatus according to claim 2, wherein said mobile computing device further comprises an application program interface in communication with said accelerometer.

4. The apparatus according to claim 3, wherein:
said accelerometer acts to detect displacement of said mobile computing device and detect a direction of displacement of said mobile computing device; and
said application program interface acts to communicate with said system processor to alter an appearance of an image on said display responsive to detection of displacement and a direction of displacement of said mobile computing device.

5. The apparatus according to claim 3, wherein said application program interface acts to call a listener object which quantitatively determines a displacement of said mobile computing device and a direction of displacement of said mobile computing device.

6. The apparatus according to claim 1, wherein an image displayed on said display comprises a document.

7. The apparatus according to claim 1, wherein said motion detection module acts to detect a sharp displacement of said mobile computing device.

8. The apparatus according to claim 1, wherein said motion detection module acts to provide a zoomed-out appearance of an image responsive to displacement of said mobile computing device in a direction generally away from a user when said display generally faces a user.

9. The apparatus according to claim 1, wherein said motion detection module acts to provide a zoomed-in appearance of an image responsive to displacement of said mobile computing device in a direction generally towards a user when said display generally faces a user.

10. The apparatus according to claim 1, wherein said motion detection module acts to provide a shifted appearance of an image responsive to displacement of said mobile computing device in a general linear direction which is coplanar with respect to a lie of said display, wherein an image shifts in a direction corresponding to the general direction of displacement of said mobile computing device.

11. The apparatus according to claim 1, wherein said motion detection module acts to page forward through an image comprising a document responsive to displacement of said mobile computing device in a general downward direction with respect to an image comprising a document on said display.

12. The apparatus according to claim 1, wherein said motion detection module acts to page backward through an image comprising a document responsive to displacement of said mobile computing device in a general upward direction with respect to an image comprising a document on said display.

13. A method comprising:
providing a mobile computing device comprising a main memory and system processor;
displaying an image on the mobile computing device;
detecting displacement of the mobile computing device;
detecting a direction of displacement of said mobile computing device; and
altering an appearance of the image responsive to said detecting of displacement and said detecting of a direction of displacement.

14. The method according to claim 13, wherein the image comprises a document.

15. The method according to claim 13, wherein said detecting of a displacement comprises detecting a sharp displacement of the mobile computing device.

16. The method according to claim 13, wherein said altering comprises providing a zoomed-out appearance of the image responsive to displacement of the mobile computing device in a direction generally away from a user when the image generally faces a user.

17. The method according to claim 13, wherein altering comprises providing a zoomed-in appearance of an image responsive to displacement of the mobile computing device in a direction generally towards a user when the image generally faces a user.

18. The method according to claim 13, wherein said altering comprises providing a shifted appearance of the image responsive to displacement of the mobile computing device in a general linear direction which is coplanar with respect to a lie of the image, wherein the image shifts in a direction corresponding to the general direction of displacement of the mobile computing device.

19. The method according to claim 13, wherein the image comprises a document and said altering comprises paging forward through the document responsive to displacement of the mobile computing device in a general downward direction with respect to the document.

20. The method according to claim 13, wherein the image comprises a document and said altering comprises paging backward through the document responsive to displacement of the mobile computing device in a general upward direction with respect to the document.

21. A computer program product comprising:
a computer readable storage medium having computer readable program code embodied therewith, the computer readable program code comprising:
computer readable program code configured to display an image on a mobile computing device;
computer readable program code configured to detect displacement of the mobile computing device;
computer readable program code configured to detect a direction of displacement of said mobile computing device; and
computer readable program code configured to alter an appearance of the image responsive to said detecting of displacement and said detecting of a direction of displacement.

22. A computer program product comprising:
a computer readable storage medium having computer readable program code embodied therewith, the computer readable program code comprising:
computer readable program code configured to detect a direction of displacement of a mobile computing device;
computer readable program code configured to alter an appearance of an image displayed on said mobile computing device responsive to said detecting a direction of displacement of a mobile computing device;
wherein to alter an appearance of an image displayed on said mobile computing device comprises one or more of implementing a zoom function, implementing a panning function, and implementing a paging function.

23. The computer program product according to claim 22, wherein implementing a zoom-in function comprises enlarging an area of the image displayed on said mobile computing device responsive to one or more of a movement of the device in a first direction and movement of the device in a second direction.

24. The computer program product according to claim 23, wherein the image comprises a word processing document; and
wherein implementing a paging function comprises one or more of paging up and paging down responsive to a movement of the mobile computing device in one or more of a first direction and a second direction.

25. The computer program product according to claim 23, wherein implementing a panning function comprises panning responsive to a movement of the mobile computing device.
